(19) United States
(12) Patent Application Publication
(10) Pub. No.: US 2018/0231043 A1
(43) Pub. Date: Aug. 16, 2018

(54) SELF-PIERCING RIVET WITH HIGH MECHANICAL STRENGTH

(71) Applicant: A. RAYMOND ET CIE, Grenoble (FR)

(72) Inventors: Mathieu COCHARD, Proveysieux (FR); Jonathan FENOLL, Seyssinet (FR); Yves-Marie DEPAIL, Grenoble (FR)

(21) Appl. No.: 15/772,008

(22) PCT Filed: Oct. 18, 2016
(86) PCT No.: PCT/FR2016/052690

§ 371 Date: Apr. 27, 2018

(30) Foreign Application Priority Data
Oct. 27, 2015 (FR) 1560252

(51) Int. Cl. F16B 19/08; F16B 19/10; F16B 37/06

(52) U.S. Cl. CPC F16B 19/083; F16B 37/067; F16B 19/1072; F16B 19/086

(57) ABSTRACT

A self-piercing rivet comprises a bearing flange and a piercing end with a radially-expandable hollow tubular body extending axially between the flange and the piercing end, the body comprising a cylindrical first portion that is adjacent to said flange, a cylindrical second portion that is adjacent to said piercing end, and an expandable barrel-shaped third portion between the cylindrical first and second portions, and a bushing arranged in the second portion that is designed to be driven in axial translation towards the flange. The bushing extends axially inside the third portion of the tubular body in such a manner that it is inserted into said first portion of the body when the third portion is completely expanded. The third portion of the body is designed to produce, before being deformed radially, an abrasion or deburring effect on the peripheral edge of a hole being pierced by said piercing end.

This application is a 371 national phase entry of PCT/FR2016/052690, filed 18 Oct. 2016, which claims benefit of French Patent Application No. 1560252, filed 27 Oct. 2015, the entire contents of which are incorporated herein by reference for all purposes.

### TECHNICAL FIELD

The invention relates to a self-piercing rivet comprising a bearing flange and a piercing end, with a radially-expandable hollow tubular body extending axially between the flange and the piercing end, the tubular body comprising a cylindrical first portion that is adjacent to the flange, a cylindrical second portion that is adjacent to the piercing end, and an expandable barrel-shaped third portion between the cylindrical first and second portions, the rivet further comprising a bushing disposed in the second portion and arranged to be driven in axial translation towards the flange in order to deform the expandable third portion radially.

### RELATED ART

It is known to use a self-drilling expansion anchor to assemble two elements in simple manner, such as assembling a part to a support.

Documents FR 2 927 382 and FR 2 992 698 describe self-drilling anchors with a head in the form of a flange, a piercing end, and an anchor body between the flange and the piercing end. The anchor body comprises a threaded portion suitable for co-operating with the thread of a screw. However, in the automotive industry those types of self-drilling anchor do not satisfy manufacturers since they have low shearing and tearing strengths, especially in the event of an impact.

Document FR 2 868 818 describes an anchor comprising an expandable body that includes an inner sheath for receiving a fastener element.

However, when those anchors are used to pierce composite elements, the anchors do not make it possible to make “clean” holes since, during piercing, they often lead to delamination and to fibers being torn, as well as to uncontrolled discharge of dust.

Finally, manufacturers seek to increase the speed with which two plates are assembled together, and more particularly when fastening is performed with access to a only one side of the plates to be assembled together.

### SUMMARY

The object of the invention is to provide another type of rivet presenting better tearing and shearing strength while being compatible with the constraints of the automotive industry.

More particularly, the invention provides a self-piercing rivet comprising a bearing flange and a piercing end, with a radially-expandable hollow tubular body extending axially between the flange and the piercing end, the tubular body comprising a cylindrical first portion that is adjacent to the flange, a cylindrical second portion that is adjacent to the piercing end, and an expandable barrel-shaped third portion between the cylindrical first and second portions, the rivet further comprising a bushing disposed in the second portion and arranged to be driven in axial translation towards the flange in order to deform the expandable third portion radially, the bushing extending axially inside the third portion of the tubular body in such a manner that it is inserted into the first portion of the tubular body when the third portion of the tubular body is completely expanded radially, the rivet being characterized in that the expandable third portion of the tubular body includes slots and strips that are interposed between the slots, and an annular zone of weakness in a transverse mid plane, and in that the strips of the third portion have an abrasive outside surface designed to produce, before being deformed radially, an abrasion or deburring effect on the peripheral edge of a hole being pierced by the piercing end.

The self-piercing rivet of the invention may further present the following characteristics:
the strips may have a sharp beveled lateral edge for producing the abrasion or deburring effect;
the bushing may have an axial length that is long enough to be flush with the flange when the third portion of the tubular body is completely expanded radially;
the first portion of the tubular body has an inside surface provided with claws for preventing the bushing from moving in axial translation;
the bushing may be threaded internally;
the bushing may be fastened to the second portion of the tubular body by a tongue and groove system;
the bushing may be fastened to the second portion of the tubular body by welding;
the bushing may present an end wall beside the second portion of the body;
the piercing end may be in the form of a hole saw;
the rivet may be made from rolled and welded sheet metal;
the rivet may be made from pressed sheet metal.

With the self-piercing rivet of the invention, two plates can be assembled together, or a part can be assembled to a support quickly and easily. The plates may also be floor mats of an automobile.

With this arrangement of the invention, a fastening can be obtained that presents high tearing and shearing strengths of more than 750 decanewtons (daN).

When the body is completely expanded radially, the bushing is blocked in part inside the first portion of the body that is adjacent to the flange, thus forming a double thickness at the first portion of the body in order to strengthen the structure of the rivet.

Assembly of the two plates, which comprises the steps of piercing and anchoring the rivet on either side of the two plates, may be quick and simplified since it may be performed in a single operation by means of a suitable tightening/traction tool.

In addition, the arrangement of the piercing end and of the hollow tubular body with its third portion that is designed for producing an abrasion or deburring effect on the peripheral edge of the pierced hole, makes it possible to make “clean” holes, but also to contain in the piercing end the discharge of dust and debris caused by piercing.

### BRIEF PRESENTATION OF THE DRAWINGS

The present invention will be better understood and other advantages appear on reading the following description and the accompanying drawings, in which:

FIG. 1 is a perspective view of the self-piercing rivet of the invention;

FIG. 2 is a plan view of the self-piercing rivet of the invention;

FIG. 3 is a profile view of the self-piercing rivet of the invention;

FIG. 4 is an axial section view of the self-piercing rivet of the invention shown in FIG. 3; and

FIG. 5 is an axial section view of the self-piercing rivet of the invention expanded radially.

### DETAILED DESCRIPTION OF EXAMPLE EMBODIMENTS

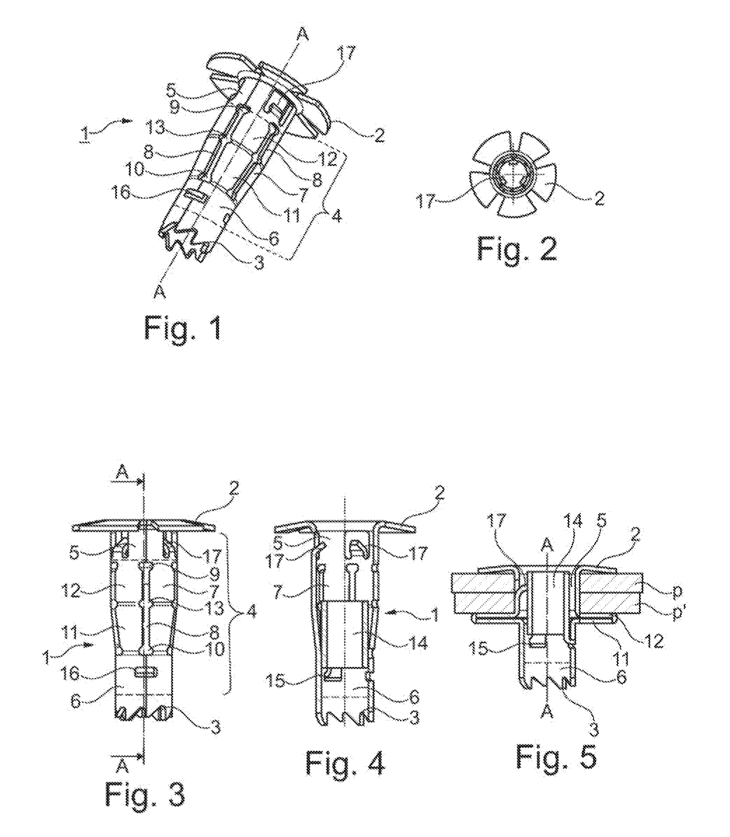

FIGS. 1 to 5 show a rivet 1 of the invention for assembling two plaques (P and P′ shown in FIG. 5). By way of non-limiting example, the plates may be fiberglass plates.

The rivet 1 includes a flange 2, coming to bear for example on one of the plates to be assembled, and a piercing end 3.

The flange 2 extends in a plane that is perpendicular to an axis AA of the rivet 1. The flange 2 may have tabs (not shown) that bite into the bearing surface in order to prevent it from moving in axial rotation.

In this embodiment, the piercing end 3 is of the double-toothed circular hole saw type. The hole saw includes an inside bore with teeth distributed circumferentially about the bore in order to reduce dust and fiber-tearing during piercing.

Without going beyond the ambit of the invention, the piercing end could be of the drill-bit type with a diamond coating (not shown).

Between the flange 2 and the piercing end 3, the rivet 1 presents a barrel-shaped tubular body 4.

The body 4 comprises three portions extending along the axis AA: a cylindrical first portion 5 adjacent to the flange 2; a cylindrical second portion 6 adjacent to the piercing end 3; and an intermediate third portion 7 between the two cylindrical portions 5, 6, which in this embodiment is in the shape of a radially-expandable barrel.

The intermediate third portion 7 includes longitudinal anchoring slots 8 extending parallel to the axis AA between two eyelets 9, 10 made at respective ends of the expandable intermediate third portion 7.

Between them, the slots 8 define bottom and top strips 11, 12, and during radial expansion of the body 4 the strips fold back onto one another, outside the body 4 so as to cause the intermediate third portion 7 to expand.

In order to further facilitate this radial expansion, intermediate other eyelets 13 are made in the middle zone of the expandable intermediate third portion 7, forming an annular zone of weakness in a transverse mid plane.

In this embodiment, the bottom strips 11 have an abrasive outside surface serving to improve the quality of piercing. The top strips 12 may also have an abrasive outside surface.

In this embodiment, the inside surface of the cylindrical first portion 5 adjacent to the flange 2 presents claws 17 that slope towards the inside of the bore.

FIG. 2 is a plan view of the rivet 1. The flange 2 presents cut out areas about an inlet orifice of the bore of the body 4.

In the invention, a bushing 14, visible in FIG. 4, is placed in the bore of the second portion 6 of the body 4.

In this embodiment, the bushing 14 is fastened to the second portion 6 by a fastener system of the tongue 15 and groove 16 type. Fastening may also be performed by welding or crimping the bushing 14 to the second portion 6 of the body 4.

In the invention, the bushing 14 has an axial length that is long enough to be fastened by a bottom portion to the second portion 6 and to extend axially inside the third portion 7 of the body 4.

The bushing 14 may be threaded internally in order to co-operate with the thread of a screw that causes the bushing 14 to move upwards towards the flange 2 when it is screwed into the bushing 14, or when traction is applied by the bushing 14 being caused to move in axial translation.

The bushing 14 may present an end wall (not shown) beside the second portion 6 of the body 4, making it possible to provide sealing from one side of the elements to be assembled to the other.

The rivet 1 is put into place, in this embodiment in the two plates in order to assemble them together, by driving the rivet 1 in rotation in the conventional screw-fastening direction, by means of a screw driver and or traction tool acting on the bushing 14, the tool passing through the flange 2, in order to make a hole in both of the plates P and P′ of FIG. 5.

When the flange 2 bears against the top plate to be assembled, the bushing 14 is caused to move upwards towards the flange 2 by driving the screw and/or by traction, which causes the expandable third portion 7 to deform radially, the bottom and top strips 11 and 12 moving apart from each other obliquely to the axis AA of the rivet 1 by opening up the anchoring slots 8 until the strips 11 and 12 form a projection underneath the assembled-together plates P, P′.

Once the third portion 7 has expanded completely, as shown in FIG. 5, the bushing 14 is thus inserted into the first portion 5 of the body 4 where it is blocked axially by the claws 17 arranged on the inside face of the first portion 5 of the body 4. The sloping claws 17 dig into the material of the bushing 14 in the event of the bushing 14 being removed from the first portion 5 of the body 4.

The axial length of the bushing 14 may be long enough to be flush with the flange 2.

In the invention, the intermediate third portion 7 formed by the slots 8 and the strips 11, 12, is designed, before being deformed radially, to produce an abrasion or deburring effect on the peripheral edge of the hole, when this third portion 7 passes through the hole after the piercing end 3 of the rivet 1 of the invention has passed therethrough.

This abrasion or deburring function may be performed by the outside surfaces of the strips 11, 12, which can be made to be rough. This function may also be performed by the lateral edge(s) of the strips 11, 12, which are beveled so as to be sharp.

Thus, the strips 11, 12 make it possible to sand the inside of the hole in order to eliminate protruding fibers and/or local areas of delamination, so as to obtain a clean and tidy surface all around the hole.

In the invention, the rivet 1 with the bushing 14 may be made from rolled and welded sheet metal, or from pressed sheet metal.

The rivet 1 can also be made entirely by molding or injection-molding a plastics material in order to be manufactured at low cost and be used for assembling two automobile floor mats together, or for assembling a floor mat to a plate, for example.

In non-limiting manner, the rivet 1 could also be used for fastening cable tunnels, for positioning heavy or lightweight fastener systems, or for internal fastening in cars with metal or composite bodies.

It could also be made by material addition in a 3D printer if, for example, only a short run is involved.

1. A self-piercing rivet comprising a bearing flange and a piercing end with a radially-expandable hollow tubular body extending axially between said flange and said piercing end, said tubular body comprising a cylindrical first portion that is adjacent to said flange, a cylindrical second portion that is adjacent to said piercing end, and an expandable barrel-shaped third portion between said cylindrical first and second portions, said rivet further comprising a bushing disposed in said second portion and arranged to be driven in axial translation towards said flange in order to deform said expandable third portion radially, said bushing extending axially inside said third portion of said tubular body in such a manner that it is inserted into said first portion of said tubular body when said third portion of said tubular body is completely expanded radially, and wherein said expandable third portion of said tubular body includes slots and strips that are interposed between said slots, and an annular zone of weakness in a transverse mid plane, and said strips of said third portion have an abrasive outside surface designed to produce, before being deformed radially, an abrasion or deburring effect on the peripheral edge of a hole being pierced by said piercing end.

2. A self-piercing rivet according to claim 1, wherein said strips have a sharp beveled lateral edge for producing the abrasion or deburring effect.

3. A self-piercing rivet according to claim 1, wherein said bushing has an axial length that is long enough to be flush with said flange when said third portion of said tubular body is completely expanded radially.

4. A self-piercing rivet according to claim 1, wherein said first portion of said tubular body has an inside surface provided with claws for preventing said bushing from moving in axial translation.

5. A self-piercing rivet according to claim 1, wherein said bushing is threaded internally.

6. A self-piercing rivet according to claim 1, wherein said bushing is fastened to said second portion of said tubular body by a tongue and groove system.

7. A self-piercing rivet according to claim 1, wherein said bushing is fastened to said second portion of said tubular body by welding.

8. A self-piercing rivet according to claim 1, wherein said bushing presents an end wall beside said second portion of said body.

9. A self-piercing rivet according to claim 1, wherein said piercing end is in the form of a hole saw.

10. A self-piercing rivet according to claim 1, wherein said self-piercing rivet is made from rolled and welded sheet metal.

11. A self-piercing rivet according to claim 1, wherein said self-piercing rivet is made from pressed sheet metal.
